(19) United States
(12) Patent Application Publication
(10) Pub. No.: US 2008/0306965 A1
(43) Pub. Date: Dec. 11, 2008

(54) FILE TRANSMITTING SERVER

(76) Inventors: Akiyoshi FUNAYAMA, Tokyo (JP); Yoshiko Shiimori, Saitama (JP)

Correspondence Address: BIRCH STEWART KOLASCH & BIRCH, PO BOX 747, FALLS CHURCH, VA, 22040-0747, US

(21) Appl. No.: 12/042,965

(22) Filed: Mar. 5, 2008

(30) Foreign Application Priority Data
Mar. 26, 2007 (JP) 2007-080145

(51) Int. Cl. G06F 17/30; G06F 15/177

(52) U.S. Cl. 707/10; 709/220; 707/E17.01

(57) ABSTRACT

Upon receipt of information transmitted from a portable terminal including unique information, it is judged whether or not received unique information exists in management information. If the unique information exists, client identification information associated with the unique information is acquired from the management information, and configuration information, which shows a configuration of an electronic file which a client has, is acquired from the client corresponding to the client identification information. The configuration information is submitted to the portable terminal. When file information expressing an electronic file shown by configuration information and an address designating an external device to which the electronic file is to be transmitted are received, the file information and address being transmitted from the portable terminal in response to the submission, the electronic file expressed by the file information is acquired, and the electronic file is transmitted to the address.

### CROSS-REFERENCE TO RELATED APPLICATION

This application claims priority under 35 USC 119 from Japanese Patent Application No. 2007-080145, the disclosure of which is incorporated by reference herein.

### BACKGROUND OF THE INVENTION

1. Field of the Invention

The present invention relates to a file transmitting server, and in particular, relates to a file transmitting server which transmits a file to a transmission destination requested by a portable terminal.

2. Description of the Related Art

Currently in companies, it is common that a work style where a personal computer for work, which is connected to an in-company intranet is provided per person, and the persons carry out work at the personal computers. Further, in the majority of cases, the preparation and storage of documents needed for work are carried out at the personal computers for work.

In this present situation, cases often arise in which a person is doing business away from the office and wishes to transmit, by email or the like, electronic information which is managed at the personal computer for work. Such as, for example, “the need unexpectedly arises at a business destination to present a document for business to the client”, or the like.

Relating to the transmitting and receiving of such electronic information, Japanese Patent Application Laid-Open (JP-A) No. 2001-188736 discloses a technique in which the information contents of a display screen of acquired contents are outputted to a printer and printed, or can be transferred by e-mail, fax or the like.

Further, a technique of transmitting a document, which is registered in a server, by e-mail from a portable terminal, is disclosed in JP-A No. 2002-183041.

However, in the technique disclosed in JP-A No. 2002-183041, the contents which are the object of the transmission (the document file or the like) must be managed at a server. Therefore, operation becomes complex and the cost for managing the server increases.

### SUMMARY OF THE INVENTION

In view of the aforementioned, the present invention provides a file transmitting server in which the load relating to the transmission of electronic information is reduced.

A first aspect of the present invention is a file transmitting server including: a storage section that stores management information where unique information that identifies a portable terminal, and client identification information that identifies a client used by a user of the portable terminal, are associated; a judging section that, upon receipt of information transmitted from the portable terminal including unique information, judges whether or not the unique information received from the portable terminal exists in the stored management information; a client identification information acquiring section that, when it is judged that the received unique information exists, acquires, from the management information, the client identification information associated with the received unique information; a configuration information acquiring section that acquires, from a client corresponding to the client identification information, configuration information showing a configuration of an electronic file that the client has; a submitting section that submits the configuration information to the portable terminal that transmitted the unique information; a file acquiring section that, upon receipt of file information expressing an electronic file shown by the configuration information, and an address designating an external device to which the electronic file is to be transmitted, acquires from the client the electronic file expressed by the file information, the file information and address being transmitted from the portable terminal to which the configuration information was submitted in response to the submission from the submitting section; and a transmitting section transmitting the electronic file to the address.

In accordance with the first aspect of the present invention, because there is no need to preliminarily store the electronic information in the file transmitting server, the load on the file transmitting server is reduced.

A second aspect of the present invention is a file transmitting server including: a storage section that stores management information where unique information, that identifies a portable terminal, and client identification information, that identifies a client used by a user of the portable terminal, are associated, and further where the client identification information and configuration information, which shows a configuration of an electronic file that the client corresponding to the client identification information has, are associated; a judging section that, upon receipt of information transmitted from the portable terminal including unique information, judges whether or not the unique information received from the portable terminal exists in the stored management information; a client identification information acquiring section that, when it is judged that the received unique information exists, acquires, from the management information, client identification information associated with the received unique information; a configuration information acquiring section that acquires, from the management information, configuration information associated with the client identification information; a submitting section that submits the configuration information to the portable terminal that transmitted the unique information; a file acquiring section that, upon receipt of file information expressing an electronic file shown by the configuration information, and an address designating an external device where the electronic file is to be transmitted, acquires from the client the electronic file expressed by the file information, the file information and address being transmitted from the portable terminal to which the configuration information was submitted in response to the submission from the submitting section; and a transmitting section transmitting the electronic file to the address.

In accordance with the second aspect of the present invention, because there is no need to preliminarily store the electronic information in the file transmitting server, the load on the file transmitting server can be reduced.

In accordance with the present invention, there can be provided a file transmitting server in which the load relating to the transmitting of electronic information is reduced.

### BRIEF DESCRIPTION OF THE DRAWINGS

Exemplary embodiment of the present invention will be described in detail based on the following figures, wherein:

FIG. 1 is drawing showing an overall configuration including a file transmitting server relating to the present exemplary embodiment, and respective electronic devices which carry out exchange of information with the server;

FIG. 2 is a drawing showing the configuration of the server;

FIG. 3 is a functional block diagram of the server, a portable terminal, and a client;

FIG. 4 is a drawing showing a management DB in a first example;

FIG. 5 is a drawing showing a management DB in a second example;

FIG. 6 is a sequence diagram showing file transmitting processing in the first example;

FIG. 7 is a sequence diagram showing file transmitting processing in the second example; and

FIG. 8A, FIG. 8B and FIG. 8C are drawings showing examples of user interfaces of the portable terminal.

### DETAILED DESCRIPTION OF THE INVENTION

An exemplary embodiment of the present invention will be described in detail hereinafter with reference to the drawings. Note that, in the present exemplary embodiment, an electronic file (hereinafter called “file”) is used as an example of electronic information.

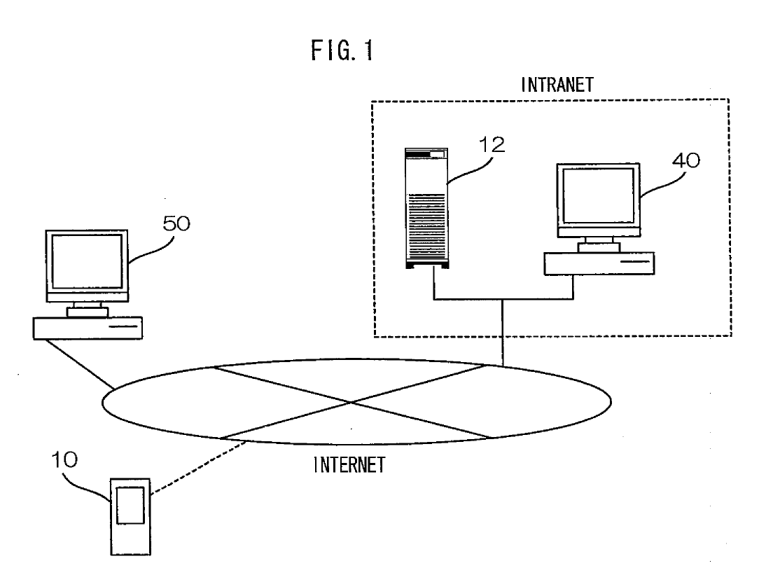

First, the overall configuration, which includes a file transmitting server relating to the present exemplary embodiment hereinafter simply called “server”) and respective electronic devices which carry out exchange of information with the server, will be described by using FIG. 1.

A server 12, a portable terminal 10, a client 40, and an external device 50 are shown in FIG. 1. Thereamong, the server 12 and the client 40 are connected within an intranet. The server 12 and the client 40 can also be connected to the internet.

The portable terminal 10 can be connected to the internet via a base station for portable terminals. Further, the external device 50 also can be connected to the internet.

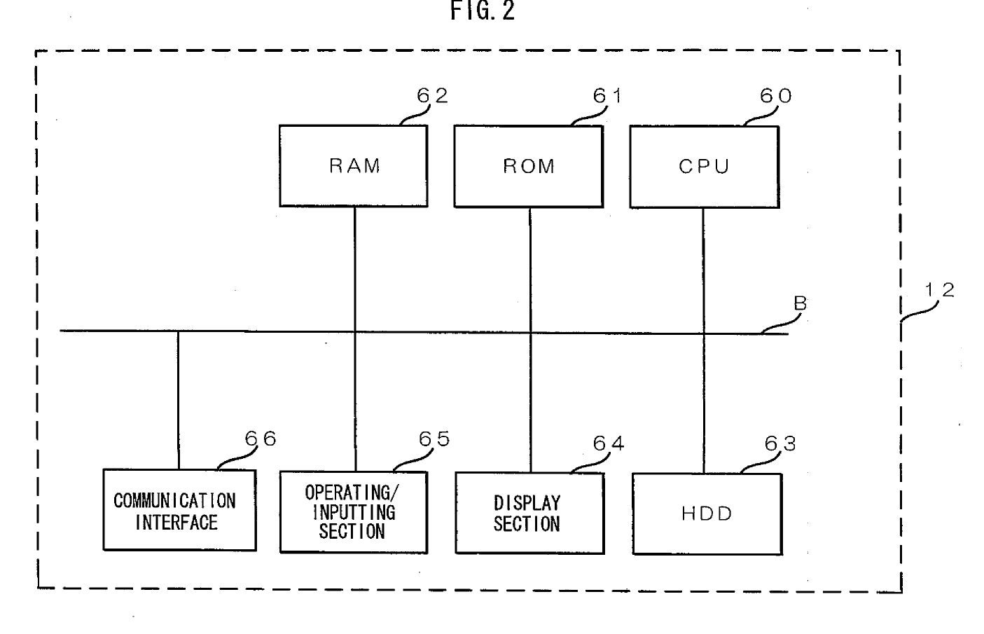

The configuration of the server 12 will be described next by using FIG. 2. The server 12 includes a CPU (Central Processing Unit) 60, a ROM (Read Only Memory) 61, a RAM (Random Access Memory) 62, an HDD (Hard Disk Drive) 63, a display section 64, an operating/inputting section 65, and a communication interface 66 which are respectively connected by a bus B.

The CPU 60 governs the overall operation of the server 12. The processings which will be described later are executed by the CPU 60. The ROM 61 is a nonvolatile storage device in which a boot program, which operates at the time of start-up of the server 12, and the like are stored. The RAM 62 is a volatile storage device in which an OS (Operating System), programs, and data are expanded. The HDD 63 is a nonvolatile storage device in which a management database (management information, hereinafter called “management DB”) which will be described later, the OS, programs, and the like are stored.

The display section 64 displays various types of predetermined information. The operating/inputting section 65 is used in cases when a user operates the server 12, and at times when a user inputs information to the server 12. The communication interface 66 is connected to the intranet and the internet, and is an NIC (Network Interface Card) or the like for carrying out communications.

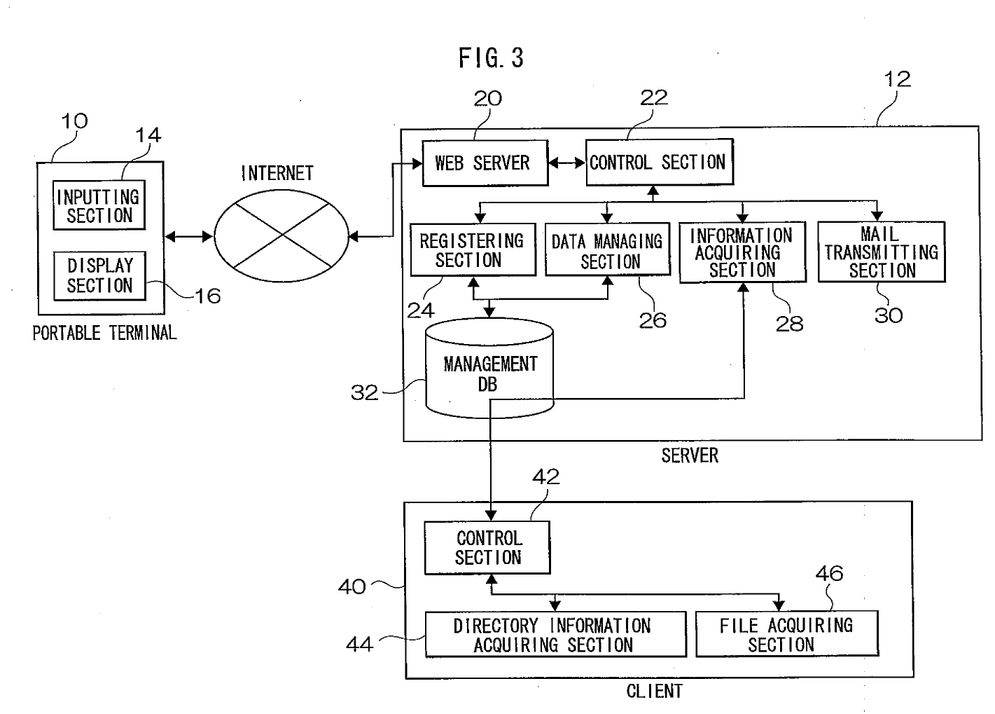

Function blocks of the server 12, the portable terminal 10, and the client 40 will be described next by using FIG. 3. First, the function block of the server 12 will be described. The server 12 is configured to include a web server 20, a control section 22, a registering section 24, a data managing section 26, an information acquiring section 28, a mail transmitting section 30, and a management DB 32.

Among these, the web server 20 is a daemon which executes web server functions, and is an interface between the portable device 10 and the client 40. The control section 22 controls the aforementioned respective sections. The registering section 24 registers, in the management DB 32 and in association with one another, unique information for identifying portable terminals and client identifying information for identifying clients that users of the portable terminals utilize.

The data managing section 26 judges whether or not unique information received from the portable terminal 10 exists in the management DB 32. If the data managing section 26 judges that received unique information exists, the data managing section 26 acquires, from the management DB 32, the client identifying information which is associated with the received unique information.

The information acquiring section 28 acquires, from the client 40, files and configuration information that shows the configuration of files that the client 40 has (called “directory information” hereinafter). The acquired directory information is transmitted to the portable terminal 10 from the control section 22. Further, the acquired file is transmitted to the external device 50 from the control section 22.

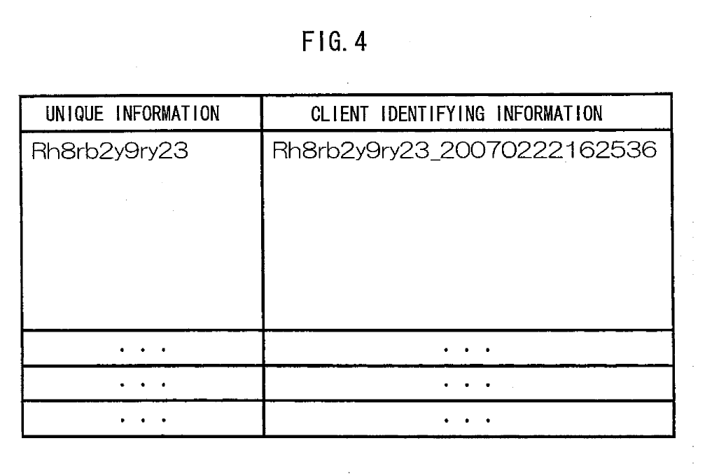

The mail transmitting section 30 transmits mail to other devices such as external devices and the like. Files can of course be attached to mail. In the present exemplary embodiment, there are two examples of the management DB 32. The first example is the management DB 32 in which unique information and client identifying information are associated, as shown in FIG. 4.

In FIG. 4, the unique information “Rh8rb2y9ry23” and the client identifying information “Rh8Rb2y9ry23₁₃ 20070222162536” are associated.

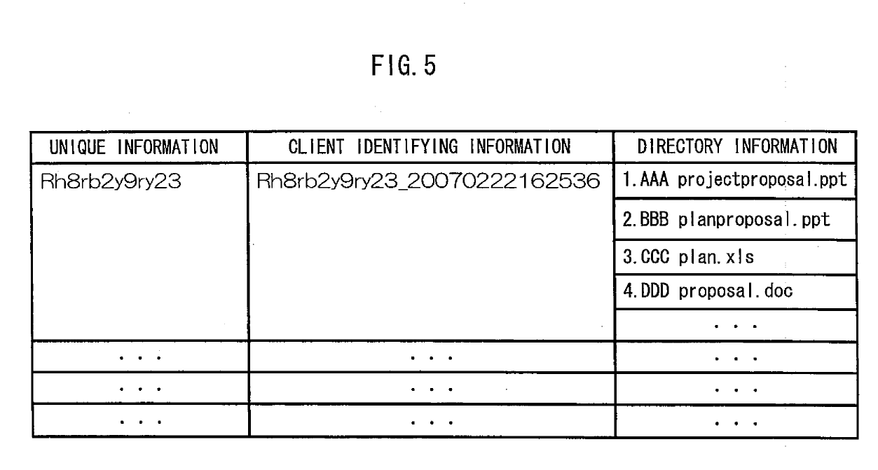

A second example is the management DB 32 shown in FIG. 5 in which unique information and client identifying information are associated, and further, the client identifying information and directory information, which shows the configuration of the files which the client corresponding to that client identifying information has, are associated.

In FIG. 5 as well, the unique information “Rh8rb2y9ry23” and the client identifying information “Rh8Rb2y9ry23_{—}20070222162536” are associated, in the same way as in FIG. 4. Further, the client identifying information “Rh8Rb2y9ry23_{—}20070222162536” and “1. AAA projectproposal.ppt, 2. BBB planproposal.ppt, 3. CCC plan.xls, 4. DDD proposal.doc” which are directory information, are associated.

These two types of management DBs will be described separately. In the present exemplary embodiment, the portable terminal 10 and the client 40 are associated in both of the management DBs 32.

Returning to the explanation of FIG. 3, the portable terminal 10 is configured to include an inputting section 14 and a display section 16. The inputting section 14 is for the user to carry out operation of the portable terminal 10 and input of characters and numbers. The display section 16 displays various types of information.

The client 40 is configured to include a control section 42, a directory information acquiring section 44, and a file acquiring section 46. The control section 42 controls the respective sections of the client 40. The directory information acquiring section 44 acquires directory information showing the configuration of the files that the client 40 itself has. The acquired directory information is transmitted to the server 12 from the control section 42. The file acquiring section 46 acquires files. The acquired file is transmitted to the server 12 from the control section 42.

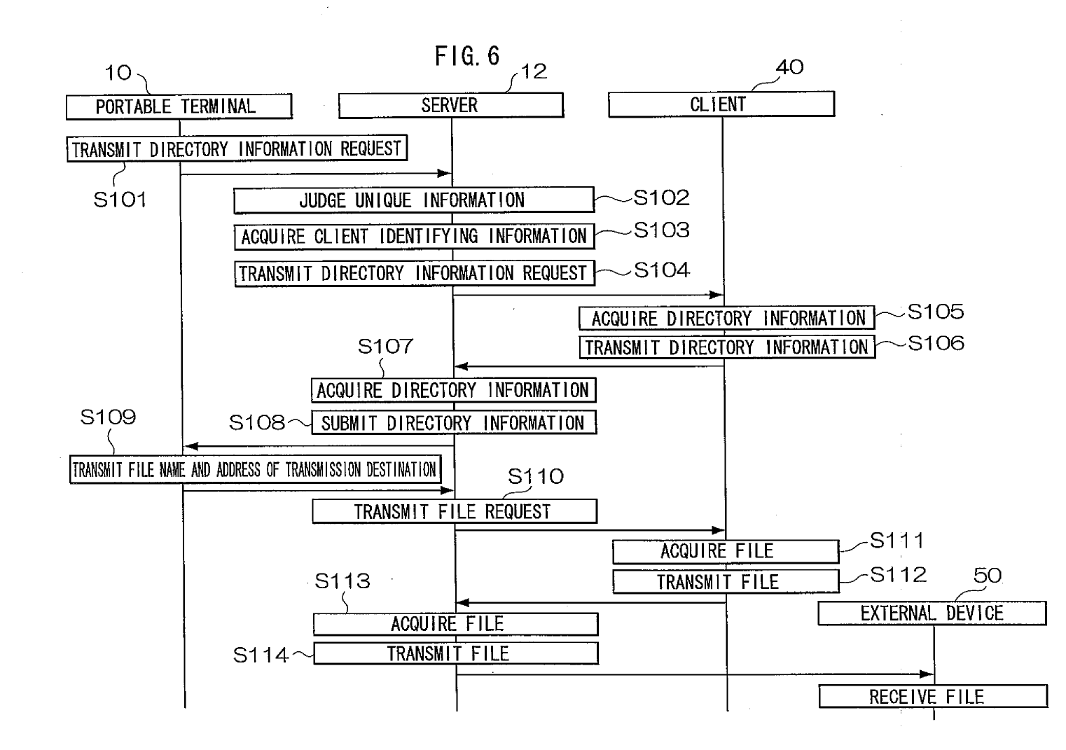

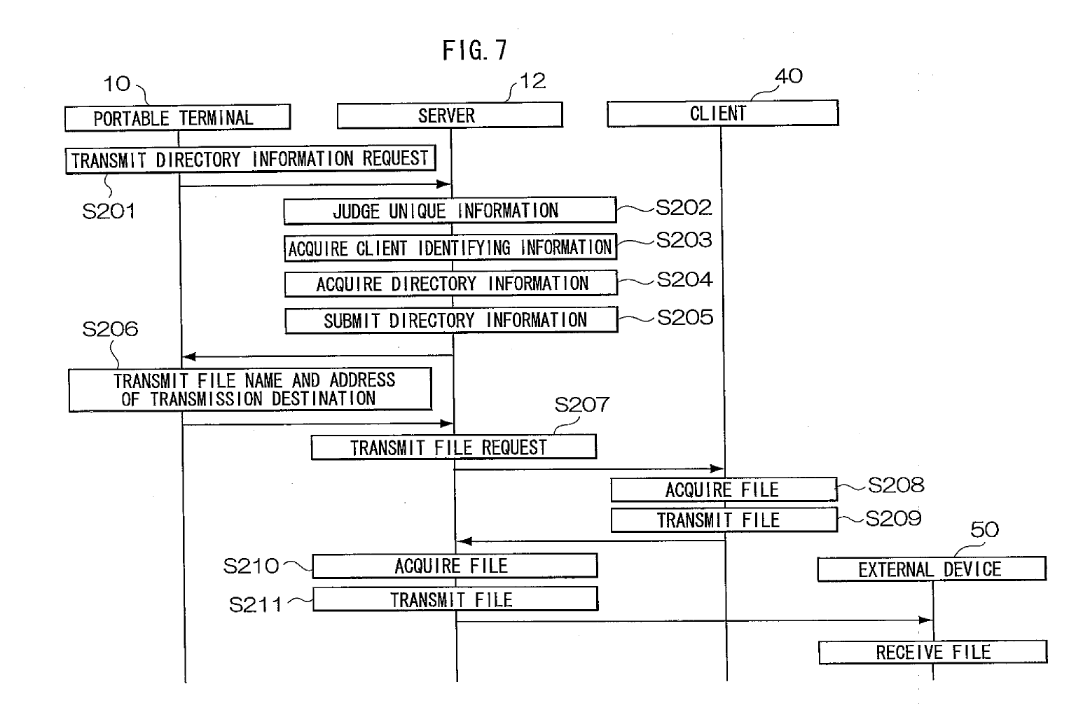

Hereinafter, the file transmitting processings which are carried out at the server 12, the portable terminal 10, the client 40, and the external device 50 will be described by using sequence diagrams (FIG. 6 and FIG. 7) of the two examples. Note that, in both sequence diagrams, the processings of the server 12 are executed by the aforementioned CPU 60. Further, at the portable terminal 10 and the client 40 as well, processings are executed by the CPUs which they have.

The sequence diagram of the first example which is shown in FIG. 6 shows processings in the case of using the management DB 32 in the first example explained in FIG. 4. In the management DB 32 explained in FIG. 4, unique information and client identifying information are associated. Therefore, when a request for directory information is received from the portable terminal 10, directory information must be requested from the client 40.

On the other hand, the sequence diagram of the second example which is shown in FIG. 7 shows processings in the case of using the management DB 32 in the second example explained in FIG. 5. The management DB 32 explained in FIG. 5 is a management DB in which unique information and client identifying information are associated, and further, directory information is associated. Accordingly, when a request for directory information is received from the portable terminal 10, it suffices to acquire it from the management DB 32, and there is no need to request the directory information from the client 40.

To elaborate on the above, first, the sequence diagram of the first example shown in FIG. 6 will be described. First, in step 101, the portable terminal 10 transmits a directory information request. This directory information request is a request to the server 12 for directory information of the client 40, and information including the unique information of the portable terminal 10 is transmitted.

In next step 102, when the server 12 receives the information including the unique information, the server 12 judges whether or not the received unique information exists in the management DB 32 (see FIG. 4) which is stored by the HDD 63. If the unique information does not exist, the server 12 either does nothing, or replies to the portable terminal 10 that there is an error and ends processing.

If it is judged that the received unique information does exist, in step 103, the server 12 acquires, from the management DB 32, the client identifying information which is associated with the received unique information.

Then, in step 104, the server 12 transmits a directory information request to the client 40. This directory information request is a request for the directory information of the client 40.

When the client 40 receives the directory information request, the client 40 acquires the directory information in step 105, and transmits the acquired directory information to the server 12 in step 106.

When the server 12 acquires the directory information of the client 40 by receiving the directory information in step 107, the server 12, in step 108, submits the acquired directory information to the portable terminal 10 which transmitted the unique information.

In step 109, the portable terminal 10 which transmitted the unique information transmits, to the server 12, file information (here, the file name) of a file the user selects from the directory information, and an address designating the external device 50 to which the file is to be transmitted.

The server 12 receives, from the portable terminal 10 to which the directory information was submitted, the file name expressing the file shown by the directory information and the address designating the external device 50 to which that file is to be transmitted. Next, in order to acquire from the client 40 the file expressed by the file name, in step 110, the server 12 transmits a file request to the client 40. The file request specifies the file name, and requests the file of that file name from the client 40.

In step 111, the client 40 which receives the file request acquires the file expressed by that file name, and, in step 112, transmits the acquired file to the server 12. In this way, the server 12 acquires the file in step 113, and, in step 114, transmits the acquired file to the aforementioned address, i.e., the external device 50. In this way, the external device 50 receives the file.

In accordance with the above-described processings, there is no need to preliminary store the files at the server 12, and therefore, the load on the server 12 can be reduced.

Next, the sequence diagram of the second example of FIG. 7 will be described. First, in step 201, the portable terminal 10 transmits a directory information request. This directory information request is a request to the server 12 for the directory information of the client 40, and information which includes the unique information of the portable terminal 10 is transmitted.

In next step 202, when the server 12 receives the information including the unique information, the server 12 judges whether or not the received unique information exists in the management DB 32 (see FIG. 5) which is stored by the HDD 63. If the unique information does not exist, the server 12 either does nothing, or replies to the portable terminal 10 that there is an error and ends processing.

If it is judged that the received unique information does exist, in step 203, the server 12 acquires, from the management DB 32, the client identifying information which is associated with the received unique information.

Further, in step 204, the server 12 acquires, from the management DB 32, the directory information which is associated with the acquired client identifying information.

When the server 12 acquires the directory information in step 204, the server 12, in step 205, submits the acquired directory information to the portable terminal 1 0 which transmitted the unique information.

In step 206, the portable terminal 10 which transmitted the unique information transmits, to the server 12, file information (here, the file name) of a file the user selects from the directory information, and an address designating the external device 50 to which the file is to be transmitted.

The server 12 receives, from the portable terminal 10 to which the directory information was submitted, the file name expressing the file shown by the directory information and the address designating the external device 50 to which that file is to be transmitted. Next, in order to acquire from the client 40 the file expressed by that file name, in step 207, the server 12 transmits a file request to the client 40. The file request specifies the file name, and requests the file of that file name from the client 40.

In step 208, the client 40 which receives the file request acquires the file expressed by that file name, and, in step 209, transmits the acquired file to the server 12. In this way, the server 12 acquires the file in step 210, and, in step 211, transmits the acquired file to the aforementioned address, i.e., the external device 50. In this way, the external device 50 receives the file.

In accordance with the above-described processings, there is no need to preliminary store the files at the server 12, and therefore, the load on the server 12 can be reduced.

Note that, in the case of processing using the above-described management DB 32 (see FIG. 5), each time the directory information of the client 40 is updated, the client 40 must transmit the updated directory information to the server 12. Further, when the server 12 receives the updated directory information, the server 12 updates the directory information of the client 40.

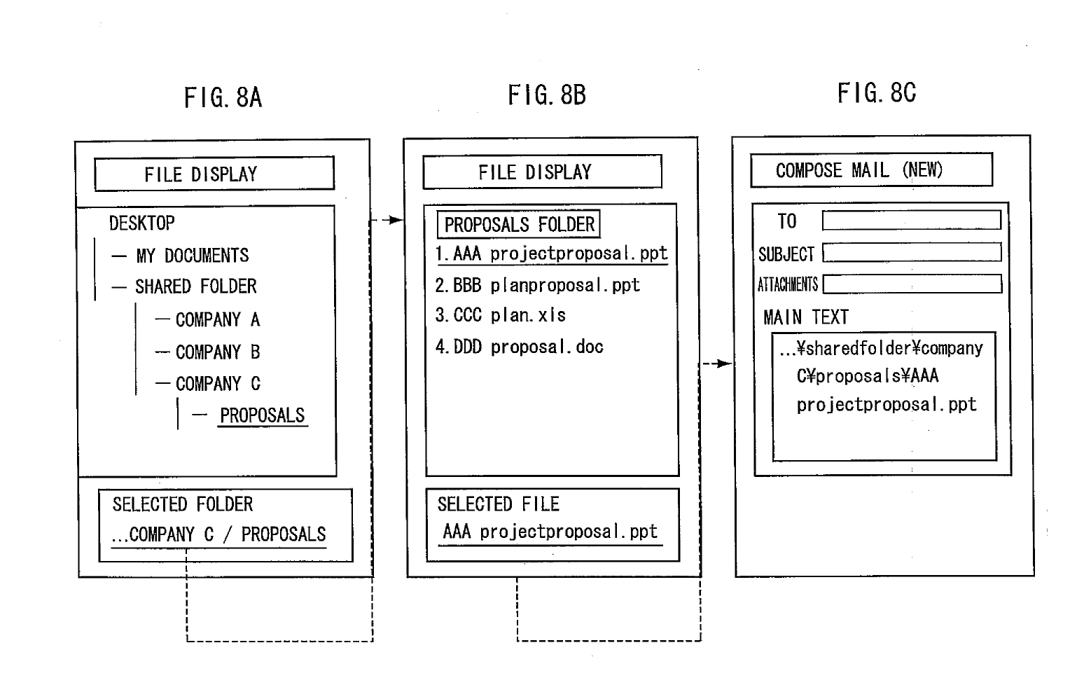

The processings of above-described step 109 and step 206 are executed at the portable terminal 10. Examples of the user interfaces at this time will be described by using FIG. 8A, FIG. 8B and FIG. 8C.

FIG. 8A shows a screen which is displayed for a user at the time when the directory information is received from the server 12. In FIG. 8A, directory information whose route is “desktop” are displayed. If the user selects the folder “ . . . company C/proposals” in this screen, the screen shown in FIG. 8B is displayed. This screen shows the directory information of the “proposals” folder, and four file names are shown in FIG. 8B.

If the user selects “AAA projectproposal.ppt” from among these four file names, the screen shown in FIG. 8C is displayed. As shown in this screen, the selected file name (in FIG. 8C, the path also is included) is attached to the main text. Further, the user inputs the mail address of the external device 50 in the address (the “To:”) box. In addition, the user may input the subject and the like.

In this way, the address and file name inputted by the user are transmitted to the server 12. Thus, operation of the portable terminal 10 in the present exemplary embodiment also is easy.

What is claimed is:

1. A file transmitting server comprising:
a storage section that stores management information where unique information that identifies a portable terminal, and client identification information that identifies a client used by a user of the portable terminal, are associated;
a judging section that, upon receipt of information transmitted from the portable terminal including unique information, judges whether or not the unique information received from the portable terminal exists in the stored management information;
a client identification information acquiring section that, when it is judged that the received unique information exists, acquires, from the management information, the client identification information associated with the received unique information;
a configuration information acquiring section that acquires, from a client corresponding to the client identification information, configuration information showing a configuration of an electronic file that the client has;
a submitting section that submits the configuration information to the portable terminal that transmitted the unique information;
a file acquiring section that, upon receipt of file information expressing an electronic file shown by the configuration information, and an address designating an external device to which the electronic file is to be transmitted, acquires from the client the electronic file expressed by the file information, the file information and address being transmitted from the portable terminal to which the configuration information was submitted in response to the submission from the submitting section; and
a transmitting section transmitting the electronic file to the address.

2. A file transmitting server comprising:
a storage section that stores management information where unique information, that identifies a portable terminal, and client identification information, that identifies a client used by a user of the portable terminal, are associated, and further where the client identification information and configuration information, which shows a configuration of an electronic file that the client corresponding to the client identification information has, are associated;
a judging section that, upon receipt of information transmitted from the portable terminal including unique information, judges whether or not the unique information received from the portable terminal exists in the stored management information;
a client identification information acquiring section that, when it is judged that the received unique information exists, acquires, from the management information, client identification information associated with the received unique information;
a configuration information acquiring section that acquires, from the management information, configuration information associated with the client identification information;
a submitting section that submits the configuration information to the portable terminal that transmitted the unique information;
a file acquiring section that, upon receipt of file information expressing an electronic file shown by the configuration information, and an address designating an external device where the electronic file is to be transmitted, acquires from the client the electronic file expressed by the file information, the file information and address being transmitted from the portable terminal to which the configuration information was submitted in response to the submission from the submitting section; and
a transmitting section transmitting the electronic file to the address.

3. A file transmitting server comprising:
a storage section that stores management information where unique information that identifies a portable terminal, and client identification information that identifies a client used by a user of the portable terminal, are associated;
a judging section that, upon receipt of information transmitted from the portable terminal including unique information, judges whether or not the unique information received from the portable terminal exists in the management information;
a client identification information acquiring section that, when it is judged that the received unique information exists, acquires, from the management information, the client identification information associated with the received unique information;
a configuration information acquiring section that acquires configuration information showing a configuration of an electronic file that the client has;
a submitting section that submits the configuration information to the portable terminal that transmitted the unique information;
a file acquiring section that, upon receipt of file information expressing an electronic file shown by the configuration information, and an address designating an external device where the electronic file is to be transmitted, acquires from the client the electronic file expressed by the file information, the file information and address being transmitted from the portable terminal in response to the submission from the submitting section; and
a transmitting section transmitting the electronic file to the address.

4. The file transmitting server of claim 3, wherein the configuration information acquiring section acquires, from the client corresponding to the client identification information, configuration information showing a configuration of an electronic file that the client has.

5. The file transmitting server of claim 3, wherein the client identification information and configuration information, which shows a configuration of an electronic file that the client corresponding to the client identification information has, are further associated in the management information.

6. The file transmitting server of claim 5, wherein the configuration information acquiring section acquires, from the management information, configuration information associated with client identification information.
